(19) United States
(12) Patent Application Publication
(10) Pub. No.: US 2026/0369923 A1
(43) Pub. Date: Nov. 19, 2026

(54) Connector Housing Assembly and Connector

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Yun (Luck) Zhang, Suzhou (CN); Rancher Chen, Shanghai (CN); Kaixuan (Evan) Jiang, Shanghai (CN); Jet Fang, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/674,706

(22) Filed: May 12, 2026

(30) Foreign Application Priority Data
May 13, 2025 (CN) 202510611203.2

(51) Int. Cl. H01R 13/52; H01R 13/6581

(52) U.S. Cl. CPC H01R 13/5202; H01R 13/6581

(57) ABSTRACT

A connector housing assembly includes an outer housing, a sealing ring, an inner housing, and a shielding shell. The outer housing has an outer peripheral wall enclosing an inner cavity and an inner peripheral wall formed in the inner cavity and spaced apart from the outer peripheral wall. The sealing ring is fitted onto the inner peripheral wall and compressed between the inner peripheral wall and a mating housing. The inner housing is inserted into the inner cavity and formed with a terminal slot. The shielding shell is fitted onto an exterior of the inner housing and installed into the inner cavity. An outer side of the inner peripheral wall has a rear positioning portion. The inner peripheral wall, the inner housing, or the shielding shell has a front positioning portion. The front and rear positioning portions are respectively pressed against front and rear ends of the sealing ring.

### CROSS-REFERENCE TO RELATED APPLICATION

This application claims the benefit of the filing date under 35 U.S.C. § 119(a)-(d) of Chinese Patent Application No. CN202510611203.2 filed on May 13, 2025, the whole disclosure of which is incorporated herein by reference.

### FIELD OF THE INVENTION

The present invention relates to a connector housing assembly and, more particularly, to a connector housing assembly and a connector comprising the connector housing assembly.

### BACKGROUND OF THE INVENTION

A connector typically includes an outer housing, an inner housing, a shielding shell, and terminals. The terminal is inserted into the inner housing, the shielding shell is fitted onto the inner housing, and the inner housing and shielding shell are inserted into the outer housing. Sometimes, in order to achieve sealing between the connector and a mating connector, it is necessary to install a sealing ring in the outer housing, which is suitable for being radially placed between the outer housing and a mating housing of the mating connector to achieve sealing between the two. Typically, in order to prevent axial movement of the sealing ring it is also necessary to install a sealing ring positioning end cap in a port of the outer housing for axial positioning of the sealing ring. However, installing a separate sealing ring positioning end cap may result in installation errors, and the insertion force during installation is very high, making installation difficult. Moreover, manufacturing a separate sealing ring positioning end cap can also lead to increased costs and decreased manufacturing efficiency.

### SUMMARY OF THE INVENTION

A connector housing assembly includes an outer housing, a sealing ring, an inner housing, and a shielding shell. The outer housing has an outer peripheral wall enclosing an inner cavity and an inner peripheral wall formed in the inner cavity and spaced apart from the outer peripheral wall. The sealing ring is fitted onto the inner peripheral wall and compressed between the inner peripheral wall and a mating housing. The inner housing is inserted into the inner cavity and formed with a terminal slot. The shielding shell is fitted onto an exterior of the inner housing and installed into the inner cavity. An outer side of the inner peripheral wall has a rear positioning portion. The inner peripheral wall, the inner housing, or the shielding shell has a front positioning portion. The front and rear positioning portions are respectively pressed against front and rear ends of the sealing ring.

### BRIEF DESCRIPTION OF DRAWINGS

The invention will now be described by way of example with reference to the accompanying figures, of which:

FIG. 1 is a perspective view of a connector housing assembly according to an exemplary embodiment;

FIG. 2 is an axial sectional view of the connector housing assembly of FIG. 1;

FIG. 3 is an exploded sectional view of the connector housing assembly of FIG. 1;

FIG. 4 is a perspective view of an inner housing and a shielding shell of the connector housing assembly of FIG. 1;

FIG. 5 is an axial sectional view of the inner housing of FIG. 4 and the shielding shell of FIG. 4;

FIG. 6 is an exploded view of the inner housing of FIG. 4 and the shielding shell of FIG. 4;

FIG. 7 is an exploded sectional view of the inner housing of FIG. 4 and the shielding shell of FIG. 4;

FIG. 8 is a perspective view of a connector housing assembly according to another exemplary embodiment;

FIG. 9 is an axial sectional view of the connector housing assembly of FIG. 8;

FIG. 10 is an exploded sectional view of the connector housing assembly of FIG. 8;

FIG. 11 is a perspective view of an inner housing and a shielding shell of the connector housing assembly of FIG. 8;

FIG. 12 is an axial sectional view of the inner housing of FIG. 11 and the shielding shell of FIG. 11;

FIG. 13 is an exploded view of the inner housing of FIG. 11 and the shielding shell of FIG. 11;

FIG. 14 is an exploded sectional view of the inner housing of FIG. 11 and the shielding shell of FIG. 11;

FIG. 15 is a perspective view of a connector housing assembly according to another exemplary embodiment;

FIG. 16 is an axial sectional view of the connector housing assembly of FIG. 15;

FIG. 17 is an axial sectional view of an outer housing of the connector housing assembly of FIG. 15;

FIG. 18 is a perspective view of an inner housing and a shielding shell of the connector housing assembly of FIG. 15; and

FIG. 19 is an axial sectional view of the inner housing of FIG. 18 and the shielding shell of FIG. 18.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

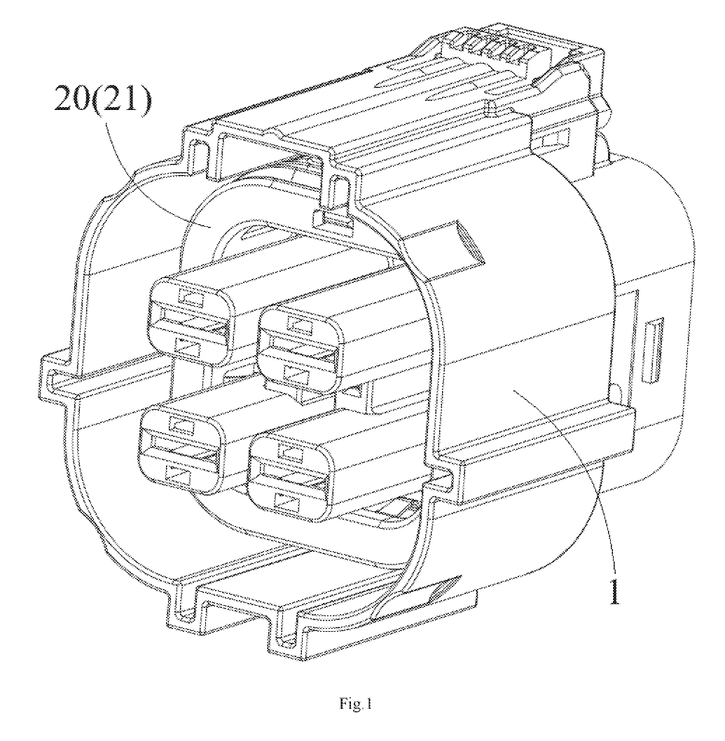

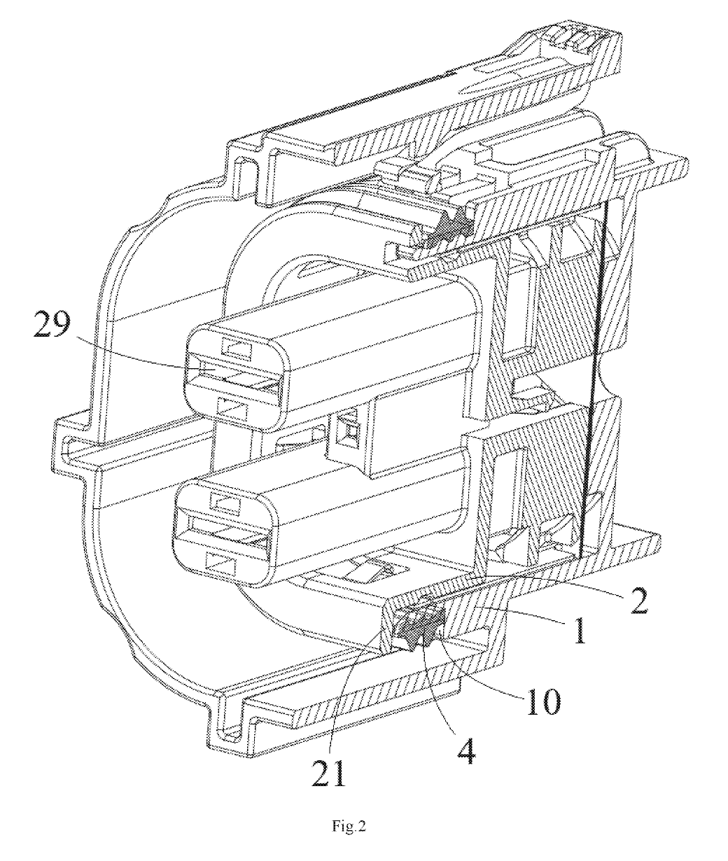

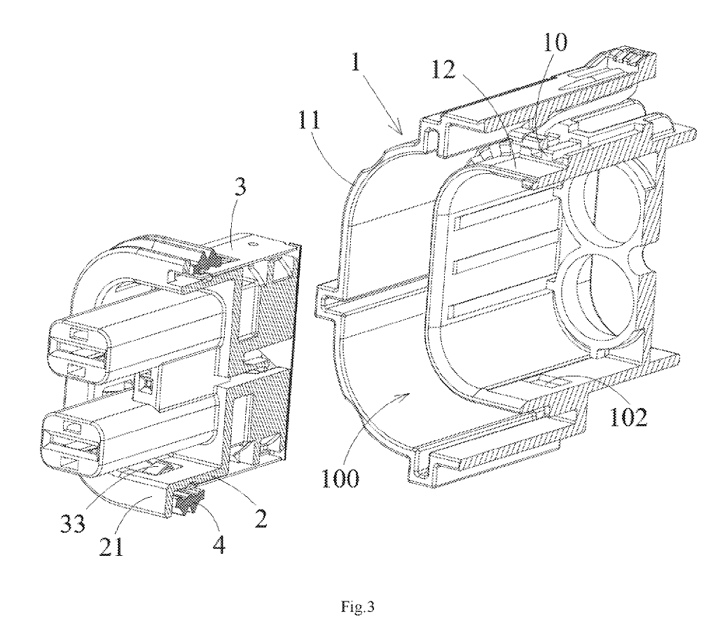

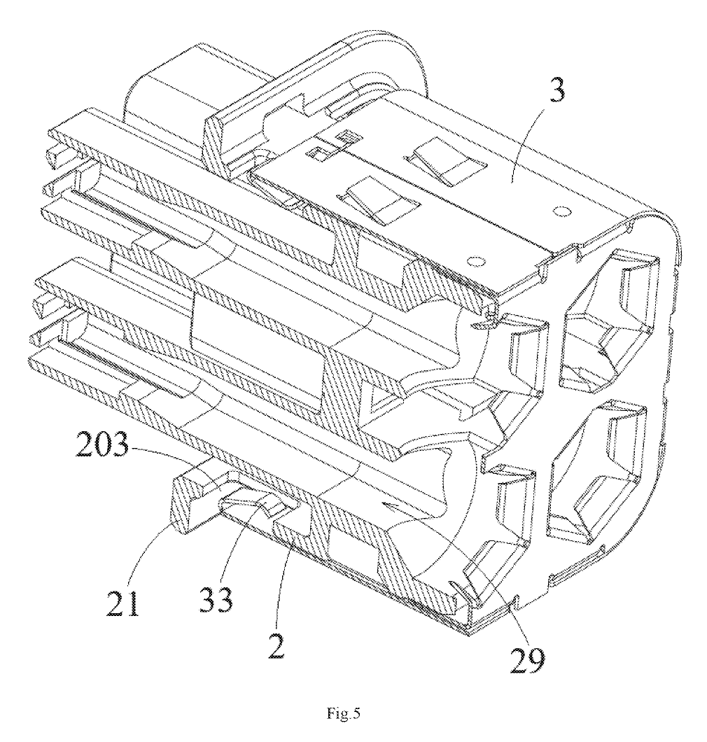

An exemplary embodiment of a connector housing assembly will now be described with reference to FIGS. 1-7. As shown in FIG. 3, the connector housing assembly includes an outer housing 1, an inner housing 2, a shielding shell 3, and a sealing ring 4. The outer housing 1 includes an outer peripheral wall 11 enclosing an inner cavity 100 and an inner peripheral wall 12 formed in the inner cavity 100 and radially spaced apart from the outer peripheral wall 11. The sealing ring 4 is fitted onto the inner peripheral wall 12 and is suitable for being radially compressed between the inner peripheral wall 12 and a mating housing of a mating connector inserted between the outer peripheral wall 11 and the inner peripheral wall 12 to achieve sealing between the two. The inner housing 2 is inserted into the inner cavity 100 of the outer housing 1 and formed with a terminal slot 29, as shown in FIG. 5, for inserting a terminal. The shielding shell 3 is fitted onto the exterior of the inner housing 2 and installed into the inner cavity 100 of the outer housing 1. As shown in FIGS. 1-3, a rear positioning portion 10 is formed on the outer side of the inner peripheral wall 12 of the outer housing 1, and a front positioning portion 20 is formed on the inner peripheral wall 12 of the outer housing 1, the inner housing 2, or the shielding shell 3. The front positioning portion 20 and the rear positioning portion 10 are respectively axially pressed against the front and rear ends of the sealing ring 4 to axially position the sealing ring 4.

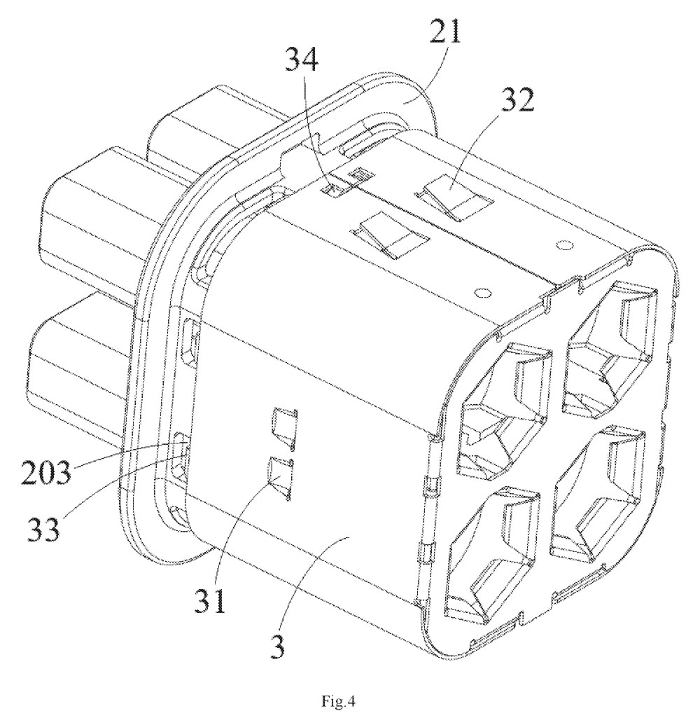

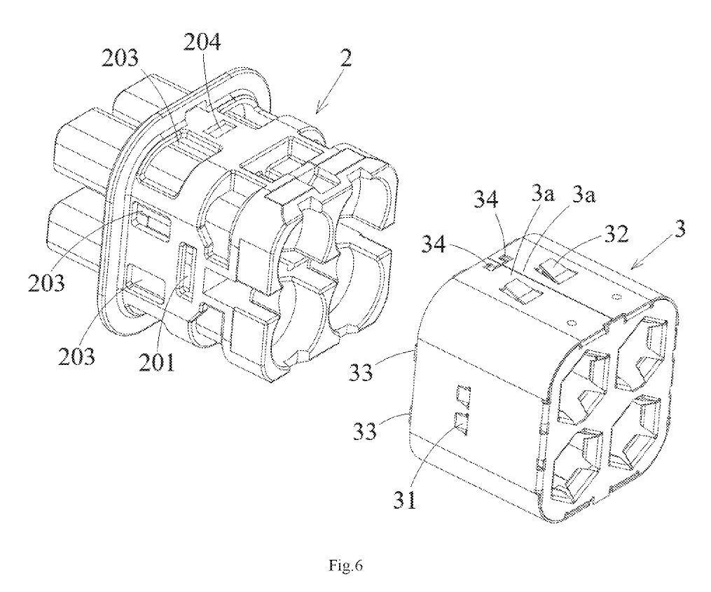

As shown in FIGS. 4 and 6, a first elastic buckle 31 that engages with the inner housing 2 and a second elastic buckle 32 that engages with the outer housing 1 are formed on the shielding shell 3 to lock the shielding shell 3 to the inner housing 2 and the outer housing 1.

A first snap slot 201, as shown in FIG. 6, is formed on the outer peripheral surface of the inner housing 2 to engage with the first elastic buckle 31, and a second snap slot 102, as shown in FIG. 3, is formed on the inner peripheral surface of the inner peripheral wall 12 of the outer housing 1 to engage with the second elastic buckle 32.

As shown in FIGS. 1-5, the front positioning portion 20 includes a radial flange 21 formed on the front end of the peripheral wall of the inner housing 2. The radial flange 21 is axially pressed against the front end of the sealing ring 4.

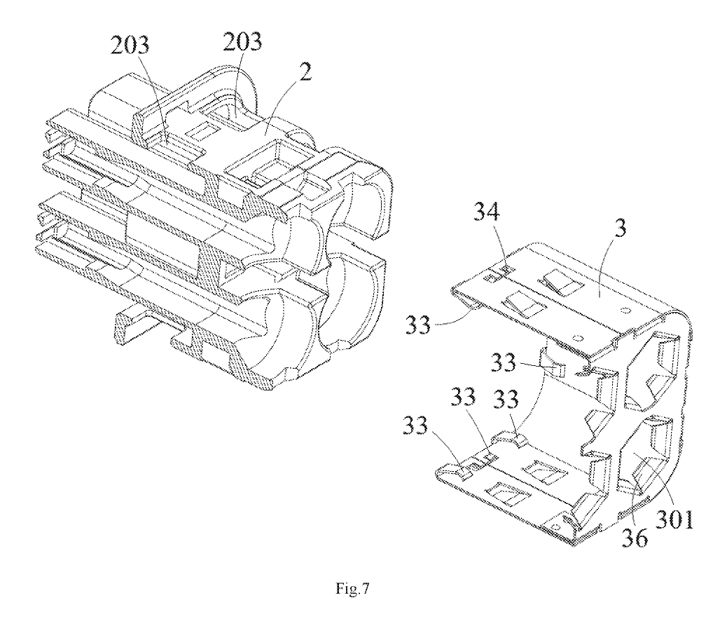

As shown in FIGS. 6-7, multiple contact spring pieces 33 are formed on the shielding shell 3, and the multiple contact spring pieces 33 are distributed at intervals in the circumferential direction of the shielding shell 3. Multiple slot holes 203 are formed in the peripheral wall of the inner housing 2, and the multiple contact spring pieces 33 protrude into the inner housing 2 through the multiple slot holes 203 for electrical contact with a mating shielding shell of the mating connector inserted into the inner housing 2.

The shielding shell 3 is an integral stamped part. This can improve manufacturing efficiency and reduce manufacturing costs.

As shown in FIG. 6, the peripheral wall of the shielding shell 3 has at least one pair of splicing edges 3a extending along the axial direction of the shielding shell 3, and elastic buckles 34 are formed on each pair of splicing edges 3a. A snap slot 204 is formed on the inner housing 2 to engage with the elastic buckle 34 on the splicing edge 3a, ensuring that each pair of splicing edges 3a will not separate in the direction of separation from each other.

As shown in FIG. 7, a cable through-hole 301 is formed in the rear end wall of the shielding shell 3 to allow a cable to pass through. The shielding shell 3 has multiple spring pieces 36 surrounding the cable through-hole 301, which are used to make electrical contact with the shielding layer of the cable.

Each of the outer housing 1 and the inner housing 2 is an integral injection molded part. This can improve manufacturing efficiency and reduce manufacturing costs.

An exemplary embodiment of a connector will now be described with reference to FIGS. 1-7. The connector includes the aforementioned connector housing assembly according to FIGS. 1-7 and a terminal. The terminal is inserted into the terminal slot 29 of the inner housing 2. The connector further comprises a cable, one end of which extends into the terminal slot 29, and the conductor of the cable is electrically connected to the terminal. The shielding layer of the cable is in electrical contact with the spring pieces 36 of the shielding shell 3 to achieve electrical connection between the shielding shell 3 and the shielding layer of the cable.

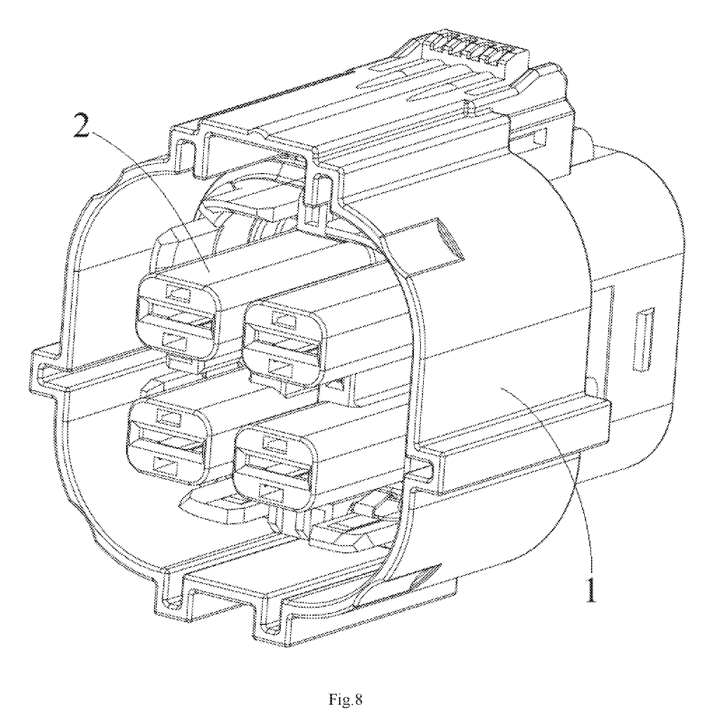

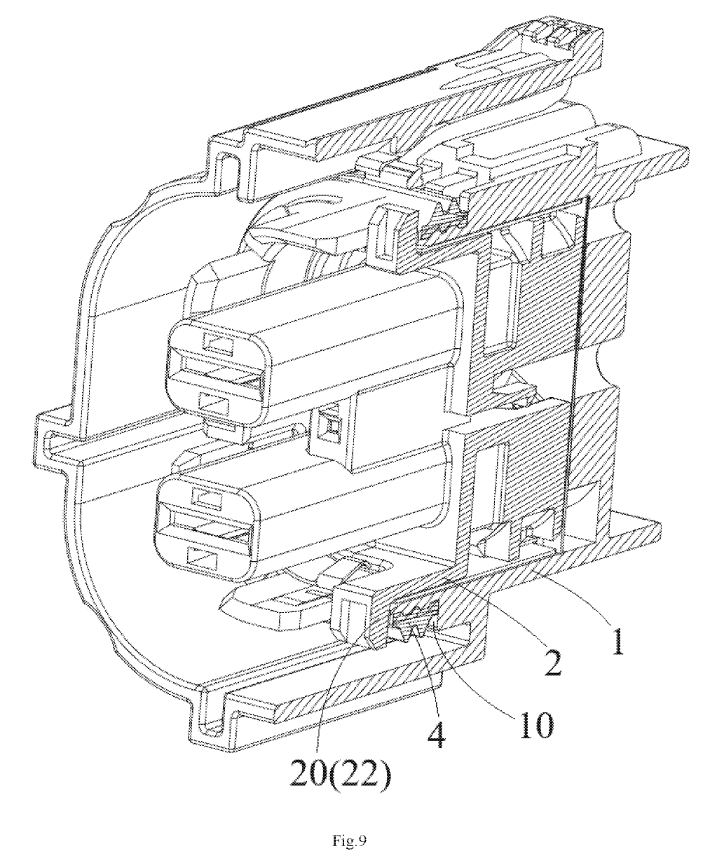

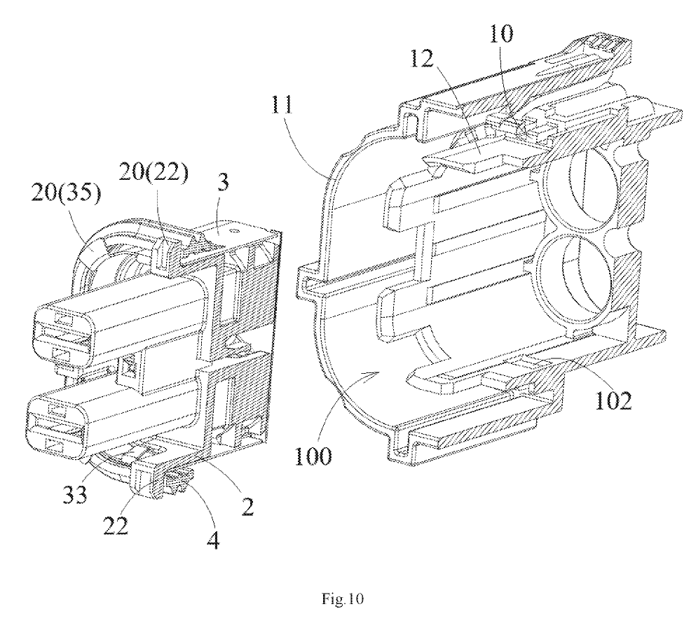

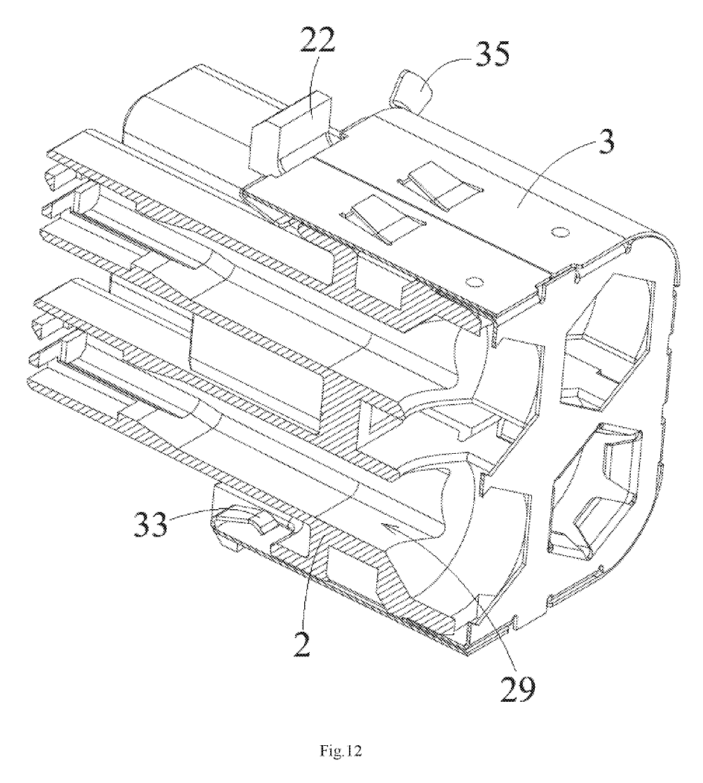

Another exemplary embodiment of a connector housing assembly will now be described with reference to FIGS. 8-14. As shown in FIGS. 9-10, the connector housing assembly includes an outer housing 1, an inner housing 2, a shielding shell 3, and a sealing ring 4. The outer housing 1 includes an outer peripheral wall 11 enclosing an inner cavity 100 and an inner peripheral wall 12 formed in the inner cavity 100 and radially spaced apart from the outer peripheral wall 11. The sealing ring 4 is fitted onto the inner peripheral wall 12 and is suitable for being radially compressed between the inner peripheral wall 12 and a mating housing of a mating connector inserted between the outer peripheral wall 11 and the inner peripheral wall 12 to achieve sealing between the two. The inner housing 2 is inserted into the inner cavity 100 of the outer housing 1 and formed with a terminal slot 29, as shown in FIG. 12, for inserting a terminal. The shielding shell 3 is fitted onto the exterior of the inner housing 2 and installed into the inner cavity 100 of the outer housing 1. As shown in FIGS. 9-10, a rear positioning portion 10 is formed on the outer side of the inner peripheral wall 12 of the outer housing 1, and a front positioning portion 20 is formed on the inner peripheral wall 12 of the outer housing 1, the inner housing 2, or the shielding shell 3. The front positioning portion 20 and the rear positioning portion 10 are respectively axially pressed against the front and rear ends of the sealing ring 4 to axially position the sealing ring 4.

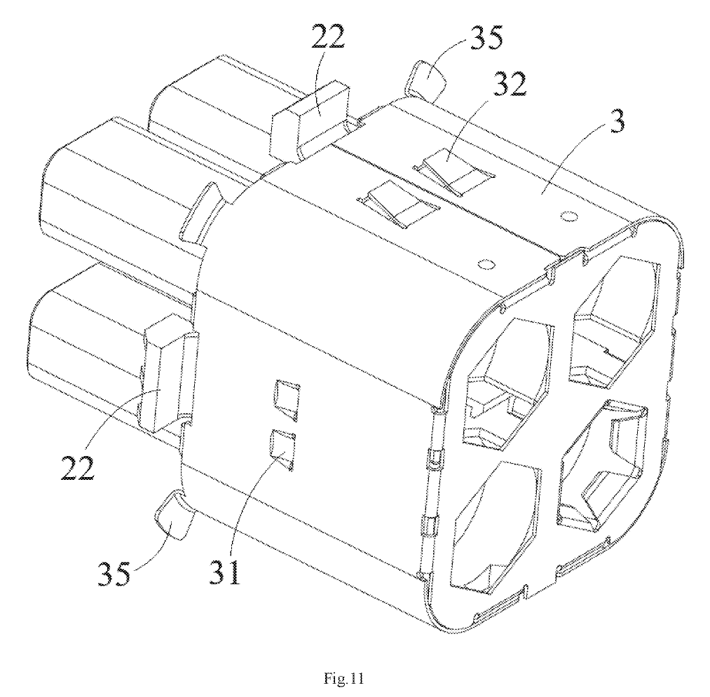

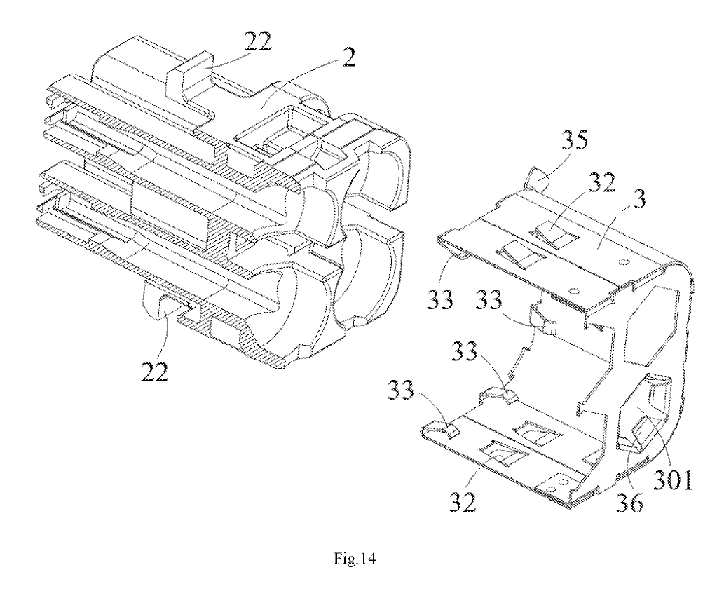

As shown in FIGS. 11 and 14, a first elastic buckle 31 that engages with the inner housing 2 and a second elastic buckle 32 that engages with the outer housing 1 are formed on the shielding shell 3 to lock the shielding shell 3 to the inner housing 2 and the outer housing 1.

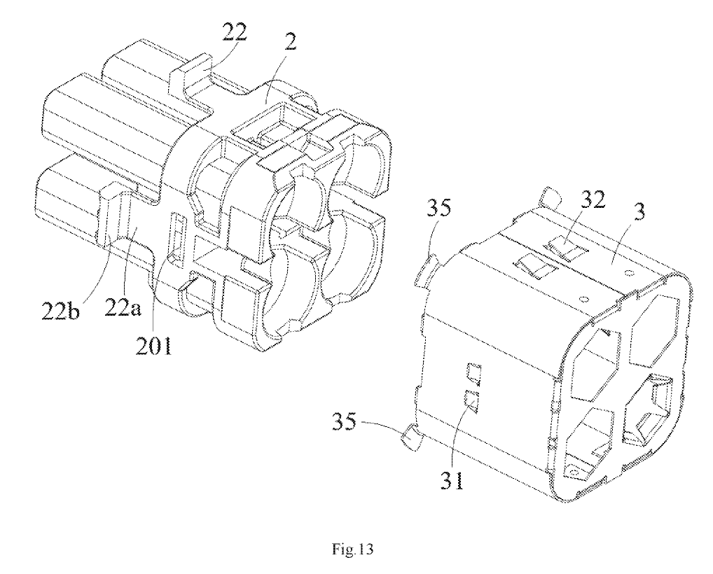

A first snap slot 201, as shown in FIG. 13, that engages with the first elastic buckle 31 is formed on the outer peripheral surface of the inner housing 2, and a second snap slot 102, as shown in FIG. 10, that engages with the second elastic buckle 32 is formed on the inner peripheral surface of the inner peripheral wall 12 of the outer housing 1.

As shown in FIGS. 9-14, the front positioning portion 20 includes multiple L-shaped cantilevers 22 formed on the inner housing 2, which are distributed at intervals in the circumferential direction of the inner housing 2. As shown in FIG. 13, the L-shaped cantilever 22 includes an axial extension arm 22a and a radial extension arm 22b connected to the front end of the axial extension arm 22a. The radial extension arm 22b is axially pressed against the front end of the sealing ring 4.

As shown in FIGS. 11-14, the front positioning portion 20 further includes multiple blocking pieces 35 formed on the front end of the shielding shell 3 and bent vertically outward. The multiple blocking pieces 35 are distributed at intervals in the circumferential direction of the shielding shell 3 and axially abut against the front end of the sealing ring 4.

As shown in FIG. 14, multiple contact spring pieces 33 are formed on the front end of the shielding shell 3, which are distributed at intervals in the circumferential direction of the shielding shell 3 and bent inward, for electrical contact with a mating shielding shell of the inserted mating connector.

The shielding shell 3 is an integral stamped part. This can improve manufacturing efficiency and reduce manufacturing costs.

The peripheral wall of the shielding shell 3 has at least one pair of splicing edges 3a (see FIG. 6) extending along the axial direction of the shielding shell 3, and elastic buckles 34 are formed on each pair of splicing edges 3a. A snap slot 204 is formed on the inner housing 2 to engage with the elastic buckle 34 on the splicing edge 3a, ensuring that each pair of splicing edges 3a will not separate in the direction of separation from each other.

As shown in FIG. 14, a cable through-hole 301 is formed in the rear end wall of the shielding shell 3 to allow a cable to pass through. The shielding shell 3 has multiple spring pieces 36 surrounding the cable through-hole 301, which are used to make electrical contact with the shielding layer of the cable.

Each of the outer housing 1 and the inner housing 2 is an integral injection molded part. This can improve manufacturing efficiency and reduce manufacturing costs.

Another exemplary embodiment of a connector will now be described with reference to FIGS. 8-14. The connector includes the aforementioned connector housing assembly according to FIGS. 8-14 and a terminal. The terminal is inserted into the terminal slot 29 of the inner housing 2. The connector further comprises a cable, one end of which extends into the terminal slot 29, and the conductor of the cable is electrically connected to the terminal. The shielding layer of the cable is in electrical contact with the spring pieces 36 of the shielding shell 3 to achieve electrical connection between the shielding shell 3 and the shielding layer of the cable.

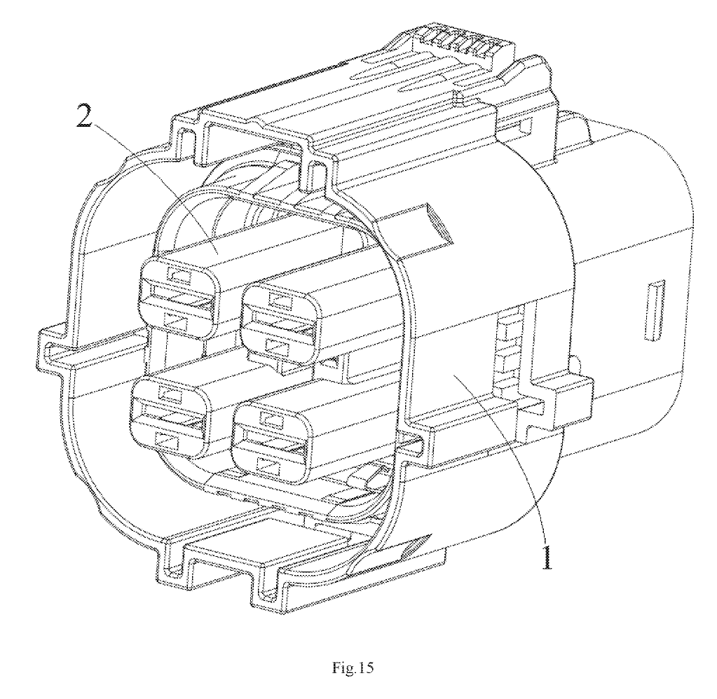

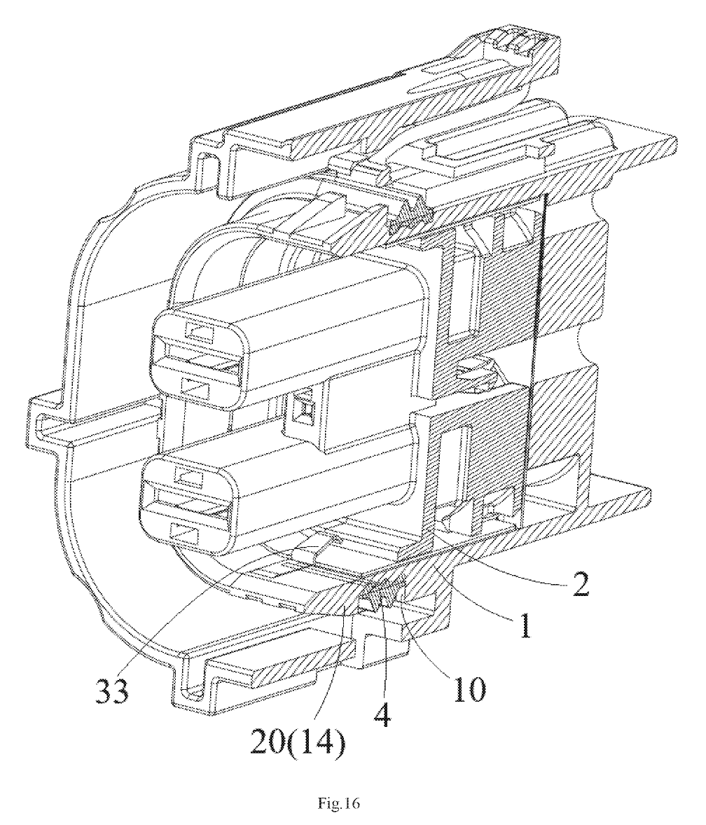

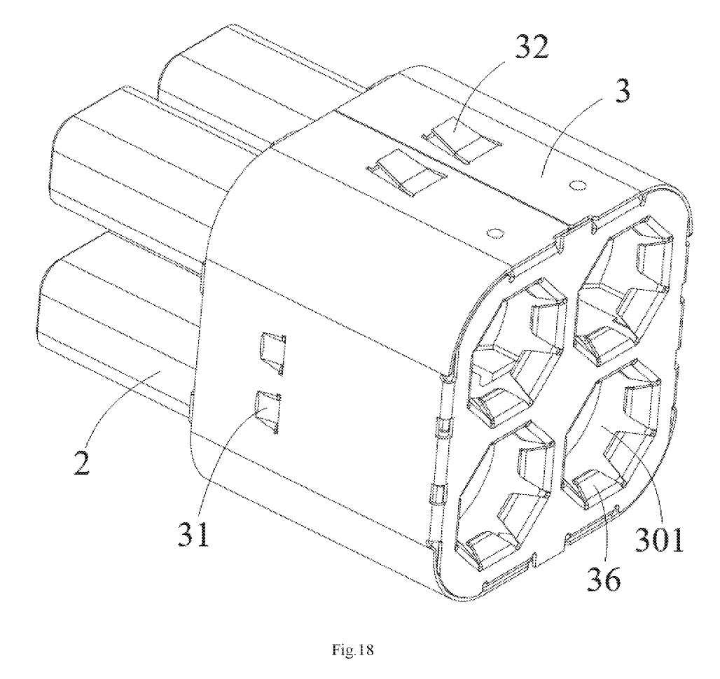

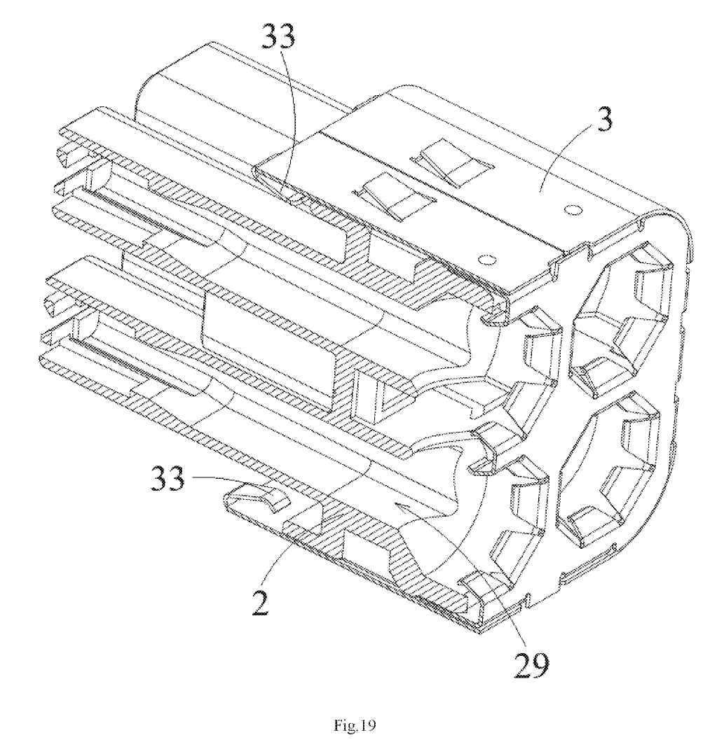

Another exemplary embodiment of a connector housing assembly will now be described with reference to FIGS. 15-19. As shown in FIGS. 16 and 18, the connector housing assembly includes an outer housing 1, an inner housing 2, a shielding shell 3, and a sealing ring 4. The outer housing 1 includes an outer peripheral wall 11 enclosing an inner cavity 100 and an inner peripheral wall 12 formed in the inner cavity 100 and radially spaced apart from the outer peripheral wall 11. The sealing ring 4 is fitted onto the inner peripheral wall 12 and is suitable for being radially compressed between the inner peripheral wall 12 and a mating housing of a mating connector inserted between the outer peripheral wall 11 and the inner peripheral wall 12 to achieve sealing between the two. The inner housing 2 is inserted into the inner cavity 100 of the outer housing 1 and formed with a terminal slot 29, as shown in FIG. 19, for inserting a terminal. The shielding shell 3 is fitted onto the exterior of the inner housing 2 and installed into the inner cavity 100 of the outer housing 1. As shown in FIG. 16, a rear positioning portion 10 is formed on the outer side of the inner peripheral wall 12 of the outer housing 1, and a front positioning portion 20 is formed on the inner peripheral wall 12 of the outer housing 1, the inner housing 2, or the shielding shell 3. The front positioning portion 20 and the rear positioning portion 10 are respectively axially pressed against the front and rear ends of the sealing ring 4 to axially position the sealing ring 4.

As shown in FIG. 18, a first elastic buckle 31 that engages with the inner housing 2 and a second elastic buckle 32 that engages with the outer housing 1 are formed on the shielding shell 3 to lock the shielding shell 3 to the inner housing 2 and the outer housing 1.

A first snap slot 201 is formed on the outer peripheral surface of the inner housing 2 to engage with the first elastic buckle 31, and a second snap slot 102 is formed on the inner peripheral surface of the inner peripheral wall 12 of the outer housing 1 to engage with the second elastic buckle 32.

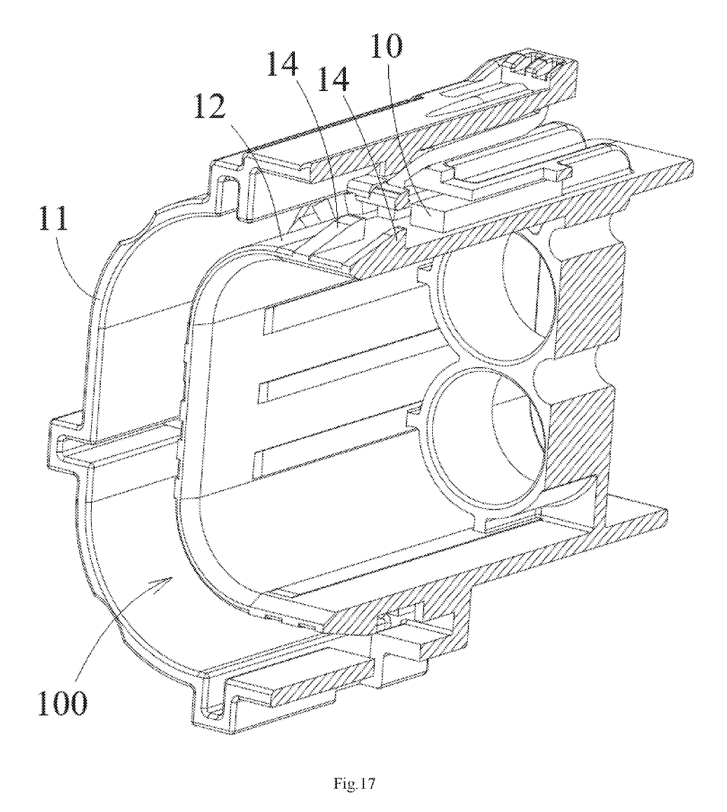

As shown in FIG. 17, the front positioning portion 20 includes multiple radial protrusions 14 formed on the outer side of the inner peripheral wall 12 of the outer housing 1. The multiple radial protrusions 14 are distributed at intervals in the circumferential direction of the inner peripheral wall 12 for axial abutment against the front end of the sealing ring 4.

As shown in FIG. 19, multiple contact spring pieces 33 are formed on the front end of the shielding shell 3, which are distributed at intervals in the circumferential direction of the shielding shell 3 and bent inward for electrical contact with the inserted mating shielding shell.

The shielding shell 3 is an integral stamped part. This can improve manufacturing efficiency and reduce manufacturing costs.

The peripheral wall of the shielding shell 3 has at least one pair of splicing edges 3a (see FIG. 6) extending along the axial direction of the shielding shell 3, and elastic buckles 34 are formed on each pair of splicing edges 3a. A snap slot 204 is formed on the inner housing 2 to engage with the elastic buckle 34 on the splicing edge 3a, ensuring that each pair of splicing edges 3a will not separate in the direction of separation from each other.

As shown in FIG. 18, a cable through-hole 301 is formed in the rear end wall of the shielding shell 3 to allow a cable to pass through. The shielding shell 3 has multiple spring pieces 36 surrounding the cable through-hole 301, which are used to make electrical contact with the shielding layer of the cable.

Each of the outer housing 1 and the inner housing 2 is an integral injection molded part. This can improve manufacturing efficiency and reduce manufacturing costs.

Another exemplary embodiment of a connector will now be described with reference to FIGS. 15-19. The connector includes the aforementioned connector housing assembly according to FIG. 15-19 and a terminal. The terminal is inserted into the terminal slot 29 of the inner housing 2. The connector further comprises a cable, one end of which extends into the terminal slot 29, and the conductor of the cable is electrically connected to the terminal. The shielding layer of the cable is in electrical contact with the spring pieces 36 of the shielding shell 3 to achieve electrical connection between the shielding shell 3 and the shielding layer of the cable.

In the aforementioned exemplary embodiments according to the present invention, the sealing ring 4 is axially positioned using positioning portions formed on the outer housing 1, inner housing 2, or shielding shell 3. Therefore, the present invention does not require a separate sealing ring positioning component, which can reduce assembly difficulty, improve manufacturing efficiency, and reduce manufacturing costs.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector housing assembly, comprising:
an outer housing having an outer peripheral wall enclosing an inner cavity and an inner peripheral wall formed in the inner cavity and radially spaced apart from the outer peripheral wall;
a sealing ring fitted onto the inner peripheral wall and radially compressed between the inner peripheral wall and a mating housing inserted between the outer peripheral wall and the inner peripheral wall to achieve sealing between the two;
an inner housing inserted into the inner cavity and formed with a terminal slot for inserting a terminal; and
a shielding shell fitted onto an exterior of the inner housing and installed into the inner cavity, a rear positioning portion is formed on an outer side of the inner peripheral wall of the outer housing, and a front positioning portion is formed on the inner peripheral wall of the outer housing, the inner housing, or the shielding shell, the front positioning portion and the rear positioning portion are respectively axially pressed against a front end and a rear end of the sealing ring to axially position the sealing ring.

2. The connector housing assembly of claim 1, wherein a first elastic buckle engaged with the inner housing and a second elastic buckle engaged with the outer housing are formed on the shielding shell to lock the shielding shell to the inner housing and the outer housing.

3. The connector housing assembly of claim 2, wherein a first snap slot is formed on an outer peripheral surface of the inner housing, the first snap slot engages with the first elastic buckle, and a second snap slot is formed on an inner peripheral surface of the inner peripheral wall of the outer housing, the second snap slot engages with the second elastic buckle.

4. The connector housing assembly of claim 1, wherein the front positioning portion has a radial flange formed on the front end of a peripheral wall of the inner housing, the radial flange is axially pressed against the front end of the sealing ring.

5. The connector housing assembly of claim 4, wherein a plurality of contact spring pieces are formed on the shielding shell, the plurality of contact spring pieces are distributed at intervals in a circumferential direction of the shielding shell.

6. The connector housing assembly of claim 5, wherein a plurality of slot holes are formed in the peripheral wall of the inner housing, each contact spring piece protrudes into the inner housing through one slot hole for electrical contact with a mating shielding shell inserted into the inner housing.

7. The connector housing assembly of claim 1, wherein the front positioning portion has a plurality of L-shaped cantilevers formed on the inner housing, the plurality of L-shaped cantilevers are distributed at intervals in a circumferential direction of the inner housing.

8. The connector housing assembly of claim 7, wherein each L-shaped cantilever has an axial extension arm and a radial extension arm connected to a front end of the axial extension arm, the radial extension arm is axially pressed against the front end of the sealing ring.

9. The connector housing assembly of claim 8, wherein the front positioning portion has a plurality of blocking pieces formed on the front end of the shielding shell and bent vertically outward, the plurality of blocking pieces are distributed at intervals in a circumferential direction of the shielding shell and axially abut against the front end of the sealing ring.

10. The connector housing assembly of claim 8, wherein a plurality of contact spring pieces are formed on the front end of the shielding shell, the plurality of contact spring pieces are distributed at intervals in a circumferential direction of the shielding shell and bent inward for electrical contact with the inserted mating shielding shell.

11. The connector housing assembly of claim 1, wherein the front positioning portion has a plurality of radial protrusions formed on the outer side of the inner peripheral wall of the outer housing, the plurality of radial protrusions are distributed at intervals in a circumferential direction of the inner peripheral wall for axially abutting against the front end of the sealing ring.

12. The connector housing assembly of claim 11, wherein a plurality of contact spring pieces are formed on the front end of the shielding shell, the plurality of contact spring pieces are distributed at intervals in a circumferential direction of the shielding shell and bent inward for electrical contact with the inserted mating shielding shell.

13. The connector housing assembly of claim 1, wherein the shielding shell is an integral stamped part.

14. The connector housing assembly of claim 13, wherein a peripheral wall of the shielding shell has at least one pair of splicing edges extending along an axial direction of the shielding shell, elastic buckles are formed on each pair of splicing edges.

15. The connector housing assembly of claim 14, wherein a snap slot is formed on the inner housing to engage with the elastic buckle on each pair of splicing edges, ensuring that each pair of splicing edges will not separate in a direction of separation from each other.

16. The connector housing assembly of claim 15, wherein a cable through-hole is formed in a rear end wall of the shielding shell to allow a cable to pass through, the shielding shell has a plurality of spring pieces surrounding the cable through-hole for electrical contact with a shielding layer of the cable.

17. The connector housing assembly of claim 1, wherein each of the outer housing and the inner housing is an integral injection molded part.

18. A connector, comprising:
a connector housing assembly including an outer housing, a sealing ring, an inner housing, and a shielding shell, the outer housing has an outer peripheral wall enclosing an inner cavity and an inner peripheral wall formed in the inner cavity and radially spaced apart from the outer peripheral wall, the sealing ring is fitted onto the inner peripheral wall and radially compressed between the inner peripheral wall and a mating housing inserted between the outer peripheral wall and the inner peripheral wall to achieve sealing between the two, the inner housing is inserted into the inner cavity and formed with a terminal slot, the shielding shell is fitted onto an exterior of the inner housing and installed into the inner cavity, a rear positioning portion is formed on an outer side of the inner peripheral wall of the outer housing, and a front positioning portion is formed on the inner peripheral wall of the outer housing, the inner housing, or the shielding shell, the front positioning portion and the rear positioning portion are respectively axially pressed against a front end and a rear end of the sealing ring to axially position the sealing ring; and
a terminal inserted into the terminal slot of the inner housing.

19. The connector of claim 18, further comprising a cable which extends into the terminal slot, a conductor of the cable is electrically connected to the terminal, a shielding layer of the cable is electrically connected to the shielding shell.
